(19) United States
(12) Patent Application Publication
(10) Pub. No.: US 2003/0112873 A1
(43) Pub. Date: Jun. 19, 2003

(54) Motion estimation for video compression systems

(76) Inventor: Gary A. Demos, Culver City, CA (US)

Correspondence Address: FISH & RICHARDSON, PC, 4350 LA JOLLA VILLAGE DRIVE, SUITE 500, SAN DIEGO, CA, 92122, US

(21) Appl. No.: 09/904,192

(22) Filed: Jul. 11, 2001

(51) Int. Cl. H04N 7/12

(52) U.S. Cl. 375/240.17; 375/240.16

(57) ABSTRACT

Methods, systems, and computer programs for determining motion vectors in a motion-compensated video compression system. In one aspect, multiple fast motion estimation methods are applied to a set of video images, with the best result from all of the matches selected for use in compression. Both AC and DC motion vector match criteria can be applied. In addition to full-pixel searches commonly used by these methods, sub-pixel searches can also be performed for each candidate motion vector, using both AC and DC match criteria. Further, hybrid combinations of full-pixel and sub-pixel fast searches can be used. Other aspects of the invention include the use of an AC match for determining motion vectors in a motion-compensated compression system; comparison of an AC match with a DC match, and selection of the best match for use in motion-compensated compression; use of the best match (AC or DC) to improve determination of motion vectors in wide dynamic range and wide contrast range images; and scaling (increasing/decreasing) AC frequency components in an AC matching process.

### TECHNICAL FIELD

This invention relates to video compression, and more particularly to motion estimation in MPEG-like video compression systems.

### BACKGROUND

MPEG Background

MPEG-2 and MPEG-4 are international video compression standards defining a video syntax that provides an efficient way to represent image sequences in the form of more compact coded data. The language of the coded bits is the “syntax.” For example, a few tokens can represent an entire block of samples (e.g., 64 samples for MPEG-2). Both MPEG standards also describe a decoding (reconstruction) process where the coded bits are mapped from the compact representation into an approximation of the original format of the image sequence. For example, a flag in the coded bitstream signals whether the following bits are to be preceded with a prediction algorithm prior to being decoded with a discrete cosine transform (DCT) algorithm. The algorithms comprising the decoding process are regulated by the semantics defined by these MPEG standards. This syntax can be applied to exploit common video characteristics such as spatial redundancy, temporal redundancy, uniform motion, spatial masking, etc. In effect, these MPEG standards define a programming language as well as a data format. An MPEG decoder must be able to parse and decode an incoming data stream, but so long as the data stream complies with the corresponding MPEG syntax, a wide variety of possible data structures and compression techniques can be used (although technically this deviates from the standard since the semantics are not conformant). It is also possible to carry the needed semantics within an alternative syntax.

These MPEG standards use a variety of compression methods, including intraframe and interframe methods. In most video scenes, the background remains relatively stable while action takes place in the foreground. The background may move, but a great deal of the scene is redundant. These MPEG standards start compression by creating a reference frame called an “intra” frame or “I frame”. I frames are compressed without reference to other frames and thus contain an entire frame of video information. I frames provide entry points into a data bitstream for random access, but can only be moderately compressed. Typically, the data representing I frames is placed in the bitstream every 12 to 15 frames (although it is also useful in some circumstances to use much wider spacing between I frames). Thereafter, since only a small portion of the frames that fall between the reference I frames are different from the bracketing I frames, only the image differences are captured, compressed, and stored. Two types of frames are used for such differences—predicted or P frames, and bi-directional Interpolated or B frames.

P frames generally are encoded with reference to a past frame (either an I frame or a previous P frame), and, in general, are used as a reference for subsequent P frames. P frames receive a fairly high amount of compression. B frames provide the highest amount of compression but require both a past and a future reference frame in order to be encoded. Bi-directional frames are never used for reference frames in standard compression technologies. After coding, an MPEG data bitstream comprises a sequence of I, P, and B frames.

Macroblocks are regions of image pixels. For MPEG-2, a macroblock is a 16×16 pixel grouping of four 8×8 DCT blocks, together with one motion vector for P frames, and one or two motion vectors for B frames. Macroblocks within P frames may be individually encoded using either intra-frame or inter-frame (predicted) coding. Macroblocks within B frames may be individually encoded using intra-frame coding, forward predicted coding, backward predicted coding, or both forward and backward (i.e., bi-directionally interpolated) predicted coding. A lightly different but similar structure is used in MPEG-4 video coding.

Motion Vector Prediction

In MPEG-2 and MPEG-4 (and similar standards, such as H.263), use of B-type (bi-directionally predicted) frames have proven to benefit compression efficiency. Motion vectors for each macroblock can be predicted by any one of the following three methods:

1) Predicted forward from the previous I or P frame.

2) Predicted backward from the subsequent I or P frame.

3) Bi-directionally predicted from both the subsequent and previous I or P frame.

Mode 1 is identical to the forward prediction method used for P frames. Mode 2 is the same concept, except working backward from a subsequent frame. Mode 3 is an interpolative mode that combines information from both previous and subsequent frames.

In addition to these three modes, MPEG-4 also supports a second interpolative motion vector prediction mode: direct mode prediction using the motion vector from the subsequent P frame, plus a delta value. The subsequent P frame's motion vector points at the previous P or I frame. A proportion is used to weight the motion vector from the subsequent P frame. The proportion is the relative time position of the current B frame with respect to the subsequent P and previous P (or I) frames.

Motion Vector Searching

The common method of determining motion vectors in motion compensated compression is to determine a full-pixel (also called “full-pel”) match of consecutive images based upon an expedient approximation. The most common method of approximation is to perform a hierarchical motion search, searching lower resolution images, and then do a small refined search about the best low resolution match point.

The match criteria which is commonly used is the Sum of Absolute Differences (SAD), which is strictly a DC match. Once a full-pixel SAD match is found, a sub-pixel search is performed, usually with a small search range of one to two pixels, up, down, left, and right, and the diagonals. The best SAD match value for the fine sub-pixel search is then used as the motion vector in most systems.

In MPEG-4, several forms of hierarchical search have been implemented in the reference encoder software. These go by the names “diamond search”, “fast motion estimation”, and “progressive fast motion estimation”. These algorithms attempt to equal the quality of an exhaustive search. An exhaustive search (as implemented in both MPEG-2 and MPEG-4 reference software encoders) tests every pixel for the whole-pixel search. This can be very slow for large search ranges.

Thus, it is desirable to achieve substantial speed in encoding without degrading quality too much. Quality is generally checked using signal to noise ratio (SNR) values and visual comparison of the final output.

In addition to resolution hierarchy methods, some of these fast motion estimation algorithms also examine motion vectors at the current location point of previous frames as a high likelihood guide to the motion at the current point in the current frame.

However, all such high-speed methods of motion estimation run afoul of pathological cases where the assumptions underlying shortcuts being used do not hold. In such cases, known fast motion estimation algorithms generally result in inferior motion vector selections.

The present invention addresses these limitations.

### SUMMARY

The invention is directed to methods, systems, and computer programs for determining motion vectors in a motion-compensated video compression system. In one aspect of the invention, multiple fast motion estimation methods are applied to a set of video images, with the best result from all of the matches selected for use in compression. This technique results in a significant improvement to the quality of motion vectors. Both AC and DC motion vector match criteria can be applied. That is, it is useful to perform a motion vector search twice, once seeking the best DC match (minimum SAD), and once seeking the best AC match, then comparing the results and selecting the match with best performance.

In addition to full-pixel searches commonly used by these methods, sub-pixel searches can also be performed for each candidate motion vector, using both the AC and DC (SAD) match criteria. Further, hybrid combinations of full-pixel and sub-pixel fast searches can be used.

Other aspects of the invention include the use of an AC match for determining motion vectors in a motion-compensated compression system; comparison of an AC match with a DC match, and selection of the best match for use in motion-compensated compression; use of the best match (AC or DC) to improve determination of motion vectors in wide dynamic range and wide contrast range images; and scaling (increasing/decreasing) AC frequency components in an AC matching process.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flowchart showing an illustrative method (which may be computer implemented) for fast motion estimation.

Like reference symbols in the various drawings indicate like elements.

### DETAILED DESCRIPTION

Combined Fast Motion Estimation

The various methods of fast motion estimation each have weaknesses. However, the weakness of one fast method may not be the same as the weakness of another method. Indeed, it has been found beneficial to utilize multiple fast motion estimation methods, and then to select the best result from all of the matches. This technique results in a significant improvement to the quality of motion vectors.

As noted below, an AC motion vector match is better in many cases than a DC motion vector match. Accordingly, in a preferred embodiment, each fast motion estimation is tested for both AC and DC (SAD) matches. That is, it is useful to perform a motion vector search twice, once seeking the best DC match (minimum SAD), and once seeking the best AC match, then comparing the results and selecting the match with best performance.

Only a modest amount of extra time is required to evaluate several fast search alternatives, particularly compared to an exhaustive search, which is very slow. For example, the common hierarchical search, the diamond search, the fast motion estimation search, and the progressive fast motion estimation search can each be tried.

In addition to the full-pixel searches commonly used by these methods, sub-pixel searches can also be performed for each candidate motion vector, using both the AC and DC (SAD) match criteria.

In addition, hybrid combinations of full-pixel and sub-pixel fast searches can be utilized. For example, a higher-resolution (double or quadruple) image can be searched, providing sub-pixel results directly from the fast search algorithms. Alternatively, an empirically determined combination of full-pixel regional searches, with sub-pixel fine searches, can yield sub-pixel optimal matches directly, alone or in conjunction with additional fine searches.

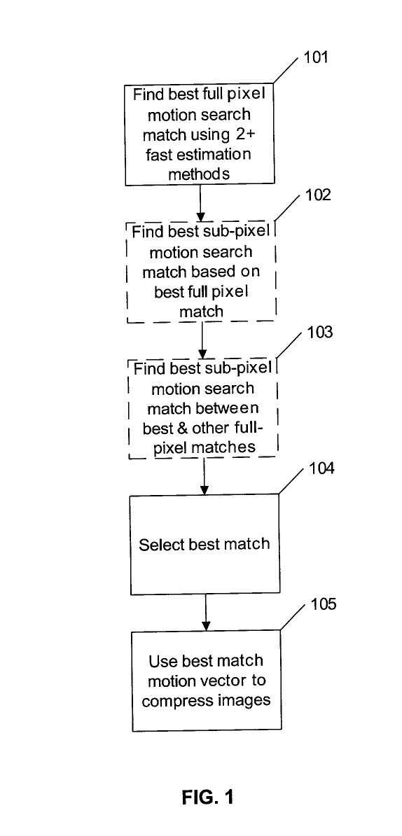

FIG. 1 is a flowchart showing an illustrative method (which may be computer implemented) for fast motion estimation:

Step 101: In a video image compression system, input a set of video images (e.g., from a video image stream) and use at least two fast motion estimation search methods on the set of video images at the full-pixel level, using one or more tests of match quality (e.g., DC or AC match, etc.) to find each search method's best match (i.e., a candidate motion vector).

Step 102: Perform a sub-pixel motion search on the best match to find the best sub-pixel match, using one or more tests of match quality (e.g., DC or AC match, etc.).

Step 103: Perform sub-pixel motion searches on one or more other fast motion estimation search method's best match, and determine the best match at the sub-pixel level for each estimation method using one or more tests of match quality (e.g., DC or AC match, etc.).

Step 104: Select the best overall match.

Step 105: Use the best match motion vector in motion compensated compression.

If sub-pixel precision is not needed, steps 102-103 can be omitted. Alternatively, only subpixel motion vector searching may be performed in lieu of full pixel searching.

Use of AC Match for Determining Motion Vectors

As noted above, the current reference implementations of MPEG 2 and MPEG-4 utilize only a DC match, in the form of a Sum of Absolute Difference algorithm (SAD). However, in many cases, it is better to use an AC match, where the DC difference is ignored. During a fade, for example, or under changes of illumination, it is better to match the actual object using an AC match and code the change in DC, rather than finding the best SAD DC match, which will find an unrelated point in the scene.

B frames can apply a proportion of previous and subsequent frames, and thus are predicted such that DC changes such as fades will automatically be predicted. In P frames, the DC difference is coded as a single term, and can be adjusted more efficiently than a difference involving many AC terms. (See co-pending U.S. Pat. No.______ , entitled “Improved Interpolation of Video Compression Frames”, filed concurrently herewith, assigned to the assignee of the present invention, and hereby incorporated by reference, for additional information on frame interpolation).

Co-pending U.S. patent application Ser. No. 09/435,277 entitled “System and Method for Motion Compensation and Frame Rate Conversion” (assigned to the assignee of the present invention, and hereby incorporated by reference), discusses the benefits of considering both the best DC match as well as both the best AC match in motion compensation and frame rate conversion. The present invention applies these similar concepts to compression. In particular, one aspect of the present invention is based in part on the recognition that it is also desirable to determine if an AC match may be more appropriate than a DC match in finding the best motion vector during compression. The next section describes techniques for computing both matches.

Various techniques may be used to decide between the best AC match and the best DC match. For example, the number of bits generated when using each predictor vector (the DC best match vector and the AC best match vector) can be compared, and the vector generating the fewest bits can be chosen for a given quantization value. Simple comparisons of the AC correlation value (seeking the highest correlation) and the DC SAD value (seeking the lowest difference) can be compared using inversion of one of the two values.

When dynamic range is extended (see, for example, co-pending U.S. patent application Ser. No. 09/798,346, entitled “High Precision Encoding and Decoding of Video Images”, assigned to the assignee of the present invention, which is hereby incorporated by reference), there may be variations in illumination, such as the sun coming out from a cloud, where an AC match is more suitable than a DC match. Also, with low contrast compression coding, an airplane going in and out of light clouds or haze might have overall DC value variation, making the AC match of the airplane itself a better motion vector predictor. Alternatively, a DC match may work better if contrast is changing, but not brightness.

It may be appropriate when using extended dynamic range or low contrast coding to code the DC value with a different methodology than the AC values. This is already implemented in MPEG-4. In addition, however, it may be desirable to utilize a different quantization parameter (QP) value for the DC coefficient than for the AC coefficients. A low contrast object in varying clouds may vary less in its contrast than in the DC shifts inherent in the clouds average gray value. In such a case, the DC value would extend over a wider range due to sunlight between and through clouds than would the low-contrast image of the airplane itself, which would remain at approximately the same range of low contrast in a logarithmic representation.

Alternatively, an airplane coming out of a cloud may also increase in contrast while having a constant DC average brightness, making the DC match a better choice. As another alternative, it may also be appropriate in such a case to match scaled AC values. An image region which is varying in average brightness (DC) and local contrast (AC) may be best matched by scaling the AC frequencies up and down, seeking a best match. In this way, an increase or decrease in contrast can occur and yet still be matched. When performing these match tests, information on the type of best match (e.g., DC SAD vs. AC vs. scaled AC) can be utilized during subsequent motion compensation steps (see, e.g., the co-pending U.S. Patent entitled “Improved Interpolation of Video Compression Frames”, referenced above).

In any event, the best match type (e.g., DC vs. AC vs. scaled AC) can be conveyed (e.g., in channel or out of channel) to a subsequent coding process to improve motion compensation and DCT or other transform coding.

This aspect of the invention thus encompasses a number of features, including the following:

Use of an AC match for determining motion vectors in motion-compensated compression.

Comparison of an AC match with a DC match, and selection of the best match for use in motion-compensated compression.

Use of the best match (AC or DC) to improve determination of motion vectors in wide dynamic range and wide contrast range images.

Scaling (increasing/decreasing) AC frequency components in an AC matching process.

Use of an RGB differences match in addition to or as an alternative to a luminance match (see Equations 1 and 2 below, with added explanation).

Match Criteria

In attempting to match a location within a current frame to find the corresponding object location in a previous or subsequent frame, a match criteria needs to be defined. In an illustrative embodiment, the principal match criteria are uniformly weighted over a pixel matching region (e.g., 15×15 pixels). At each pixel, a computation is made of the absolute value of the sum of the differences of red, green, and blue (R, G, B), plus the sum of the absolute values of the individual differences, for the current frame (“self”) and a frame being matched (“other”). This is shown as follows:

pixel_diff=abs(r_self−r_other+g_self−g_other+b_self−b_other)+abs(r_self−r_other)+abs(g_self−g_other)+abs(b_self−b_other) (EQ. 1)

diff_dc=sum_over_region(pixel_diff) (EQ. 2)

Equation 1 essentially has two terms. The first term, being the absolute value of the summed differences in pixel colors, helps reduce the influence of noise on the match where the original camera sensor (or film) has uncorrelated color channels (which is usually the case). Noise will most often be uncorrelated between the colors, and is therefore likely to go in opposite directions in one color versus another, thus canceling out the difference, and helping find a better match. The second term sums the absolute values of the differences (thus an SAD, but applied to all color primaries). The reason for the use of this term in Equation 1 is to attempt to detect a hue shift, since the first term may not be noise, but rather might have a sum of zero if the red channel increases by the same amount as the blue channel decreases (when green stays the same). Thus, these two terms together help detect a match using RGB differences. It is also possible to bias toward green, which is the typical perceptual bias used in luminance equations, or to use luminance itself for the match. However, the ability to reduce uncorrelated noise as an affect of the match by keeping the red, green, and blue channels separate in the above function is lost when using luminance. However, luminance matches should also work acceptably. (Note: it is typical in MPEG-type motion vector searches to use only luminance matching). Further, both RGB differences and luminance matches can be combined.

Equation 2 sums the results of applying Equation 1 over the match region. Equation 2 is thus used to provide a total match value or confidence factor for each particular match region/search region comparison. The best match in the search will be the location of the minimum value for diff_dc in Equation 2. This is primarily a DC match.

However, this “area difference” function does not detect cases where an object is moving into the light, or out of the light, or where the overall picture is fading up or fading down to black. In such cases, it would still be useful to match the objects in the image, since noise reduction and frame rate motion conversions would still work properly, even if the overall lightness of the match is changing. To detect a match under such conditions, a different “AC” (for changing DC conditions) match is required that removes the overall change in brightness. Such a match requires an AC correlation function, wherein the DC (or constant component) bias is removed from the area difference, or other AC match technique. This can be accomplished by multiplying the pixels of both images instead of subtracting them, thus finding the best correlation for the match function. For the multiplication, the DC term can be removed by subtracting the average value of each match region prior to multiplication. The multiplication then goes both positive and negative about the average value, thus determining only the AC match. In one preferred embodiment, the AC correlation match function is generated as follows:

average_self(red)=sum over_region(red_self)/pixels_in_region

average_self(grn)=sum_over_region(grn_self)/pixels_in_region

average_self(blu)=sum_over_region(blu_self)/pixels_in_region

average_other(red)=sum_over_region(red_other)/pixels_in_region

average_other(grn)=sum_over_region(grn_other)/pixels_in_region

average_other(blu)=sum_over_region(blu_other)/pixels_in_region (EQ. 3)

pixel_diff_ac(red)=(red_self−average_self(red))*(red_other−average_other(red))

pixel_diff_ac(grn)=(grn_self−average_self(grn))*(grn_other average−other(grn))

pixel_diff_ac(blu)=(blu_self−average_self(blu))*(blu_other−average_other(blu)) (EQ. 4)

diff_ac=sum_over_region(pixel_diff_ac(red)+pixel_diff_ac(grn)+pixel_diff_ac(blu)) (EQ. 5)

This AC match function is a maximum area correlation/convolution function. The average value of the regions being matched provides the DC terms (Equation set 3). The regions to be matched have their pixels multiplied after subtracting the DC terms (Equation set 4), and then these multiplied values are summed (Equation 5). The largest value of this sum over the search region is the best correlation, and is therefore the best match.

In a second embodiment, an AC SAD difference function may be used, such as the following:

pixel_ac_diff(red)=abs((red_self−avg_self(red))−(red_other−avg_other(red)))

pixel_ac_diff(grn)=abs((grn_self−avg_self(grn))−(grn_other−avg_other(grn)))

pixel_ac_diff(blu)=abs((blu_self−avg_self(blu))−(blu_other−avg _other(blu))) (EQ. 6)

ac_diff=sum_over_region(pixel_ac_diff(red)+pixel_ac_diff(grn)+pixel_ac_diff(blu)) (EQ. 7)

Luminance information can also be used in determining the best AC match function (biasing the difference more heavily towards green). Nothing is lost here from using luminance or other color weightings, since the multiplicative function does not inherently help cancel noise between the channels. However, hue changes having the same luminance could incorrectly match. This is avoided by using the sum of the correlations of all three colors. It should be noted, however, that an AC match function cannot find a hue and brightness match between frames, only a detail match. A hue or brightness match is fundamentally a DC match, using the minimum area difference function (Equation 2) described above (which is equivalent to subtracting the two DC average values of the match regions).

For regions without detail (such as black, out-of-focus, or constant-color areas), camera sensor (or film grain) noise tends to dominate the signal, leading to artificial matches. Thus, a combination of the influence from the AC maximum area correlation match and the DC minimum area difference match is likely to form the optimal match function if attempting to provide for matches during fades or lighting changes (which are statistically fairly rare, typically being about 1% of a movie). The combination of these two match functions may require scale factors and inversion of one of the functions (typically the AC maximum area correlation match function), since the system determines an overall minimum for the DC minimum area difference match function, whereas the AC maximum area correlation match function involves the maximum correlation value using products. Also, both of these functions have different sensitivities to matching. However, suitable adjustments to weightings, scale factors, and perhaps exponentiation can yield any desired balance between these two independent functions in finding the optimal match as a combination of the minimum difference and the maximum correlation over the match search region.

As an alternative to combining the two matching functions described above to form a single matching function, another (somewhat more preferable) approach is to retain the separate match functions as independent results. This allows somewhat independent matches to create independent motion vectors and motion compensated results for later combination and subsequent processing.

Implementation

The invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention. For example, some of the steps described above may be order independent, and thus can be performed in an order different from that described. Accordingly, other embodiments are within the scope of the following claims.

What is claimed is:

1. A method for motion estimation in a motion-compensated video compression system, including:
(a) applying at least two fast motion estimation search methods to a set of video images and selecting a candidate best match motion vector for each search method;
(b) selecting a best motion vector from the candidate best match motion vectors; and
(c) applying the best match motion vector to compress the set of video images.

2. The method of claim 1, wherein selecting a candidate best match motion vector for each search method includes:
(a) applying an AC match criteria to determine an AC best match motion vector;
(b) applying a DC match criteria to determine a DC best match motion vector; and
(c) selecting the better match of the AC best match motion vector and the DC best match motion vector to be the candidate best match motion vector for the search method.

3. The method of claim 1, wherein each fast motion estimation search method is applied to subpixels.

4. The method of claim 1, wherein each fast motion estimation search method is applied to full pixels.

5. The method of claim 4, further including:
(a) performing a sub-pixel motion search on the set of video images, based on the best motion vector, to generate a set of sub-pixel motion vectors; and
(b) selecting, as the best match motion vector, the best motion vector from the set of sub-pixel motion vectors.

6. The method of claim 5, wherein selecting the best match motion vector includes:
(a) applying an AC match criteria to the set of sub-pixel motion vectors to determine an AC best match sub-pixel motion vector;
(b) applying a DC match criteria to the set of sub-pixel motion vectors to determine a DC best match sub-pixel motion vector; and
(c) selecting the better match of the AC best match sub-pixel motion vector and the DC best match sub-pixel motion vector to be the best match motion vector.

7. The method of claim 1, further including:
(a) performing a set of sub-pixel motion searches on the set of video images, based on the best motion vector for each fast motion estimation search method, to generate a set of subpixel motion vectors for each fast motion estimation search method;
(b) selecting, from each set of sub-pixel motion vectors for each fast motion estimation search method, a best match sub-pixel motion vector; and
(c) selecting, as the best match motion vector, the best motion vector from the best match sub-pixel motion vectors.

8. The method of claim 7, wherein selecting a best match includes:
(a) applying an AC match criteria to determine an AC best match; and
(b) applying a DC match criteria to determine a DC best match.

9. A method for determining the quality of motion vector determinations for a set of video images in a motion-compensated video compression system, including applying an AC match algorithm in determining best match motion vector candidates for the set of video images.

10. A method for determining the quality of motion vector determinations for a set of video images in a motion-compensated video compression system, including:
(a) applying an AC match algorithm in determining a best match AC motion vector candidate for the set of video images;
(b) applying a DC match algorithm in determining a best match DC motion vector candidate for the set of video images; and
(c) selecting, as a best match, the better of the best match AC motion vector candidate and the best match DC motion vector candidate.

11. The method of claim 10, further including preferentially selecting the AC match algorithm in determining motion vectors for wide dynamic range and wide contrast range images.

12. The method of claim 10, further including preferentially selecting the DC match algorithm in determining motion vectors for images having changing contrast.

13. The method of claim 10, wherein the AC match algorithm has frequency components, and further including scaling the frequency components while applying the AC match algorithm to find a best match.

14. The method of claim 10, wherein the DC match algorithm uses at least an RGB difference match.

15. The method of claim 10, wherein the DC match algorithm uses at least a luminance match.

16. The method of claim 10, further including conveying the type of best match to a subsequent coding process.

17. A computer program, stored on a computer-readable medium, for motion estimation in a motion-compensated video compression system, the computer program comprising instructions for causing a computer to:
(a) apply at least two fast motion estimation search computer programs to a set of video images and selecting a candidate best match motion vector for each search computer program;
(b) select a best motion vector from the candidate best match motion vectors; and
(c) apply the best match motion vector to compress the set of video images.

18. The computer program of claim 17, wherein the instructions for causing the computer to select a candidate best match motion vector for each search computer program include instructions for causing the computer to:
(a) apply an AC match criteria to determine an AC best match motion vector;
(b) apply a DC match criteria to determine a DC best match motion vector; and
(c) select the better match of the AC best match motion vector and the DC best match motion vector to be the candidate best match motion vector for the search computer program.

19. The computer program of claim 17, wherein each fast motion estimation search method is applied to subpixels.

20. The computer program of claim 17, wherein each fast motion estimation search method is applied to full pixels.

21. The computer program of claim 20, further including instructions for causing a computer to:
(a) perform a sub-pixel motion search on the set of video images, based on the best motion vector, to generate a set of sub-pixel motion vectors; and
(b) select, as the best match motion vector, the best motion vector from the set of sub-pixel motion vectors.

22. The computer program of claim 21, wherein the instructions for causing the computer to select the best match motion vector include instructions for causing the computer to:
(a) apply an AC match criteria to the set of sub-pixel motion vectors to determine an AC best match sub-pixel motion vector;
(b) apply a DC match criteria to the set of sub-pixel motion vectors to determine a DC best match sub-pixel motion vector; and
(c) select the better match of the AC best match sub-pixel motion vector and the DC best match sub-pixel motion vector to be the best match motion vector.

23. The computer program of claim 17, further including instructions for causing a computer to:
(a) perform a set of sub-pixel motion searches on the set of video images, based on the best motion vector for each fast motion estimation search computer program, to generate a set of sub-pixel motion vectors for each fast motion estimation search computer program;
(b) select, from each set of sub-pixel motion vectors for each fast motion estimation search computer program, a best match sub-pixel motion vector; and
(c) select, as the best match motion vector, the best motion vector from the best match sub-pixel motion vectors.

24. The computer program of claim 23, wherein the instructions for causing the computer to select a best match include instructions for causing the computer to:
(a) apply an AC match criteria to determine an AC best match; and
(b) apply a DC match criteria to determine a DC best match.

25. A computer program, stored on a computer-readable medium, for determining the quality of motion vector determinations for a set of video images in a motion-compensated video compression system, the computer program comprising instructions for causing a computer to apply an AC match algorithm in determining best match motion vector candidates for the set of video images.

26. A computer program, stored on a computer-readable medium, for determining the quality of motion vector determinations for a set of video images in a motion-compensated video compression system, the computer program comprising instructions for causing a computer to:
(a) apply an AC match algorithm in determining a best match AC motion vector candidate for the set of video images;
(b) apply a DC match algorithm in determining a best match DC motion vector candidate for the set of video images; and
(c) select, as a best match, the better of the best match AC motion vector candidate and the best match DC motion vector candidate.

27. The computer program of claim 22, further including instructions for causing a computer to preferentially select the AC match algorithm in determining motion vectors for wide dynamic range and wide contrast range images.

28. The computer program of claim 22, further including instructions for causing a computer to preferentially select the DC match algorithm in determining motion vectors for images having changing contrast.

29. The computer program of claim 22, wherein the AC match algorithm has frequency components, and further including instructions for causing a computer to scale the frequency components while applying the AC match algorithm to find a best match.

30. The computer program of claim 22, wherein the DC match algorithm uses at least an RGB difference match.

31. The computer program of claim 2, wherein the DC match algorithm uses at least a luminance match.

32. The computer program of claim 22, further including instructions for causing a computer to convey the type of best match to a subsequent coding process.

33. A system for motion estimation in a motion-compensated video compression system, including:
(a) means for applying at least two fast motion estimation search methods to a set of video images and selecting a candidate best match motion vector for each search method;
(b) means for selecting a best motion vector from the candidate best match motion vectors; and
(c) means for applying the best match motion vector to compress the set of video images.

34. The system of claim 33, wherein the means for selecting a candidate best match motion vector for each search method includes:
(a) means for applying an AC match criteria to determine an AC best match motion vector;
(b) means for applying a DC match criteria to determine a DC best match motion vector; and
(c) means for selecting the better match of the AC best match motion vector and the DC best match motion vector to be the candidate best match motion vector for the search method.

35. The system of claim 33, wherein each fast motion estimation search method is applied to subpixels.

36. The system of claim 33, wherein each fast motion estimation search method is applied to full pixels.

37. The system of claim 36, further including:
(a) means for performing a sub-pixel motion search on the set of video images, based on the best motion vector, to generate a set of sub-pixel motion vectors; and
(b) means for selecting, as the best match motion vector, the best motion vector from the set of sub-pixel motion vectors.

38. The system of claim 37, wherein the means for selecting the best match motion vector includes:
(a) means for applying an AC match criteria to the set of sub-pixel motion vectors to determine an AC best match sub-pixel motion vector;
(b) means for applying a DC match criteria to the set of sub-pixel motion vectors to determine a DC best match sub-pixel motion vector; and
(c) means for selecting the better match of the AC best match sub-pixel motion vector and the DC best match sub-pixel motion vector to be the best match motion vector.

39. The system of claim 33, further including:
(a) means for performing a set of sub-pixel motion searches on the set of video images, based on the best motion vector for each fast motion estimation search method, to generate a set of sub-pixel motion vectors for each fast motion estimation search method;
(b) means for selecting, from each set of sub-pixel motion vectors for each fast motion estimation search method, a best match sub-pixel motion vector; and
(c) means for selecting, as the best match motion vector, the best motion vector from the best match sub-pixel motion vectors.

40. The system of claim 39, wherein the means for selecting a best match includes:
(a) means for applying an AC match criteria to determine an AC best match; and
(b) means for applying a DC match criteria to determine a DC best match.

41. A system for determining the quality of motion vector determinations for a set of video images in a motion-compensated video compression system, including:
(a) means for inputting the set of video images; and
(b) means for applying an AC match algorithm in determining best match motion vector candidates for the set of video images.

42. A system for determining the quality of motion vector determinations for a set of video images in a motion-compensated video compression system, including:
(a) means for applying an AC match algorithm in determining a best match AC motion vector candidate for the set of video images;
(b) means for applying a DC match algorithm in determining a best match DC motion vector candidate for the set of video images; and
(c) means for selecting, as a best match, the better of the best match AC motion vector candidate and the best match DC motion vector candidate.

43. The system of claim 42, further including means for preferentially selecting the AC match algorithm in determining motion vectors for wide dynamic range and wide contrast range images.

44. The system of claim 42, further including means for preferentially selecting the DC match algorithm in determining motion vectors for images having changing contrast.

45. The system of claim 42, wherein the AC match algorithm has frequency components, and further including means for scaling the frequency components while applying the AC match algorithm to find a best match.

46. The system of claim 42, wherein the DC match algorithm uses at least an RGB difference match.

47. The system of claim 46, wherein the DC match algorithm uses at least a luminance match.

48. The system of claim 42, further including means for conveying the type of best match to a subsequent coding process.
